(19) United States
(12) Patent Application Publication
(10) Pub. No.: US 2018/0276641 A1
(43) Pub. Date: Sep. 27, 2018

(54) POINT OF SALE DEVICE, INFORMATION PROCESSING DEVICE, METHOD FOR CONTROLLING POINT OF SALE DEVICE

(71) Applicant: NEC Corporation, Minato-ku, Tokyo (JP)

(72) Inventor: Katsutoshi HAYASHI, Tokyo (JP)

(73) Assignee: NEC Corporation, Minato-ku, Tokyo (JP)

(21) Appl. No.: 15/763,561

(22) PCT Filed: Sep. 15, 2016
(86) PCT No.: PCT/JP2016/004208

§ 371 Date: Mar. 27, 2018

(30) Foreign Application Priority Data
Sep. 30, 2015 (JP) 2015-195361

(51) Int. Cl. G06Q 20/20

(52) U.S. Cl. CPC G06Q 20/209; G06Q 20/201

(57) ABSTRACT

As a new technology for easily grasping a total payment amount at a plurality of stores and a balance amount with respect to a predetermined value, provided is an information processing device including: a first information acquisition unit 11 which acquires first information from an issued receipt on which the first information is printed, the first information including at least one of a totalized amount obtained by totalizing payment amounts of past transactions and a balance amount obtained by subtracting the totalized amount from a target amount being a lower limit for receiving a predetermined service; a second information acquisition unit 12 which acquires a payment amount of a new transaction; an update unit 13 which updates first information, based on the payment amount of the new transaction; and a recording unit 14 which prints the updated first information on a newly-issued receipt on which new transaction information is printed.

### TECHNICAL FIELD

The present invention relates to a POS device, an information processing device, a POS system, a POS device control method, an information processing method, and a program recording medium.

### BACKGROUND ART

PTL 1 discloses a receipt issuance device which prints, on a receipt, a code indicating a commodity purchase history which includes data such as a name, a quantity, and a date of purchase of a commodity purchased by a customer in the past. When a new transaction is performed, the receipt issuance device reads the code, acquires a commodity purchase history, and adds data such as a name and a quantity of a commodity purchased in the new transaction to the commodity purchase history. Then, the device prints a code indicating the commodity purchase history after the addition on a receipt for the new transaction.

PTL 2 discloses a host device which aggregates sales results for each customer, based on customer-purchased commodity data collected from an accounting terminal, performs ranking, based on the sales results, and transmits issuance control data of a coupon to the accounting terminal, depending on the rank.

Furthermore, PTL 3 discloses a related art.

### CITATION LIST

### Patent Literature

PTL 1: Japanese Unexamined Patent Application Publication No. 2010-9158

PTL 2: Japanese Unexamined Patent Application Publication No. 2002-367037

PTL 3: Japanese Unexamined Patent Application Publication No. 2015-49555

### SUMMARY OF INVENTION

### Technical Problem

There is a service offering a predetermined service (e.g. a discount service or a free service) when a total payment amount at one or more predetermined stores exceeds a predetermined value. For example, such a service is used at a shopping mall or the like having a plurality of stores.

In such a service, a means for grasping a total payment amount at a plurality of stores and a balance amount with respect to the aforementioned predetermined value is required. For example, a user grasps the amounts by referring to a receipt received from each store, adding up payment amounts in person, and subsequently subtracting the total from the predetermined value, thus causing a problem which the aforementioned work is time-consuming and cumbersome for the user.

In PTL 1, while a code indicating a purchase history is printed on a receipt, information indicating a total payment amount at a plurality of stores and a balance amount with respect to the aforementioned predetermined value is not printed, and therefore the aforementioned problem cannot be solved.

There is a problem with PTL 2 which, in order to aggregate sales results, an accounting device with a function of transmitting customer-purchased commodity data to a host device is required.

### Solution to Problem

The present invention provides a POS device including:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which acquires a payment amount of a new transaction;

an update means which updates the first information, based on the payment amount of the new transaction; and

a recording means which prints the updated first information on a newly-issued receipt on which the new transaction information is printed.

The present invention further provides an information processing device including:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from a POS device;

an update means which updates the first information, based on the payment amount of the new transaction; and

a transmission means which transmits the updated first information to the POS device.

The present invention further provides a POS device control method including:

a first information acquisition step of acquiring first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition step of acquiring a payment amount of a new transaction;

an update step of updating the first information, based on the payment amount of the new transaction; and

a recording step of printing the updated first information on a newly-issued receipt on which the new transaction information is printed.

The present invention further provides an information processing method including:

a first information acquisition step of acquiring first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition step of receiving a payment amount of a new transaction from a POS device;

an update step of updating the first information, based on the payment amount of the new transaction; and

a transmission step of transmitting the updated first information to the POS device.

The present invention further provides a program causing a computer to function as:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which acquires a payment amount of a new transaction;

an update means which updates the first information, based on the payment amount of the new transaction; and

a recording means which prints the updated first information on a newly-issued receipt on which the new transaction information is printed.

The present invention further provides a program causing a computer to function as:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from a POS device;

an update means which updates the first information, based on the payment amount of the new transaction; and

a transmission means which transmits the updated first information to the POS device.

The present invention further provides a POS system including a POS device and an information processing device, wherein

an information processing device includes:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from the POS device;

an update means which updates the first information, based on the payment amount of the new transaction; and

a transmission means which transmits the updated first information to the POS device, and

the POS device includes

a recording means which prints the updated first information received from the information processing device on a newly-issued receipt on which the new transaction information is printed.

### Advantageous Effects of Invention

The present invention enables an easy grasp of a total payment amount at a plurality of stores and a balance amount with respect to a predetermined value.

### BRIEF DESCRIPTION OF DRAWINGS

FIG. 1 is a diagram illustrating an example of an overview of a POS device according to the present example embodiment.

FIG. 2 is a diagram illustrating a hardware configuration example of the POS device according to the present example embodiment.

FIG. 3 is a diagram illustrating an example of a functional block diagram of the POS device according to the present example embodiment.

FIG. 4 is a diagram illustrating an example of a receipt issued by the POS device according to the present example embodiment.

FIG. 5 is a flowchart illustrating an example of a processing flow in the POS device according to the present example embodiment.

FIG. 6 is a diagram illustrating an example of a receipt issued by the POS device according to the present example embodiment.

FIG. 7 is a diagram illustrating an example of an overview of an information processing device (attached device) according to the present example embodiment.

FIG. 8 is a diagram illustrating a hardware configuration example of the information processing device according to the present example embodiment.

FIG. 9 is a diagram illustrating an example of an overview of an information processing device (attached device) according to the present example embodiment.

FIG. 10 is a diagram illustrating an example of an overview of an information processing device (attached device) according to the present example embodiment.

FIG. 11 is a diagram illustrating an example of a functional block diagram of a POS device according to the present example embodiment.

FIG. 12 is a diagram schematically illustrating an example of a list registered in the POS device and an information processing device, according to the present example embodiment.

FIG. 13 is a diagram illustrating an example of a receipt issued by the POS device according to the present example embodiment.

FIG. 14 is a diagram schematically illustrating an example of a list registered in the POS device and the information processing device, according to the present example embodiment.

FIG. 15 is a diagram illustrating an example of a receipt issued by the POS device according to the present example embodiment.

FIG. 16 is a diagram illustrating an example of an overview of an information processing device (server) according to the present example embodiment.

FIG. 17 is a diagram illustrating an example of an overview of an information processing device (server) according to the present example embodiment.

FIG. 18 is a diagram schematically illustrating an example of a list registered in a POS device and an information processing device, according to the present example embodiment.

FIG. 19 is a diagram schematically illustrating an example of a list registered in the POS device and the information processing device, according to the present example embodiment.

FIG. 20 is a diagram illustrating an example of a functional block diagram of the information processing device according to the present example embodiment.

FIG. 21 is a diagram illustrating an example of a functional block diagram of the information processing device according to the present example embodiment.

FIG. 22 is a flowchart illustrating an example of a processing flow in the information processing device according to the present example embodiment.

### DESCRIPTION OF EMBODIMENTS

### First Example Embodiment

First, an overview of the present example embodiment will be described. A POS device according to the present example embodiment executes input acceptance processing of accepting an input for registering a transaction target (e.g. an article or a service), checkout processing of checking out a transaction content, issuance processing of issuing a receipt (e.g. a receipt by a print medium), and the like.

For example, the POS device is used at a store such as a retail store. The POS device is suitable for use at a store participating in a service offering a predetermined service when a total payment amount at one or more predetermined stores exceeds a predetermined value.

The predetermined service includes various types and is not particularly restricted. For example, a service by which a parking fee becomes free, a service by which a parking fee is discounted, and a service by which a predetermined gift (e.g. shaved ice or a gift certificate) is given, each service provided when a total payment amount exceeds a predetermined value, and the like may be considered.

The POS device according to the present example embodiment prints first information (history information) in addition to transaction information (transaction statement) on a receipt issued each time a transaction is performed, the first information including at least one of a totalized value of payment amounts up to that point and a difference between a predetermined value and the totalized value. For example, the transaction statement includes a transaction date and time, a store name, a purchased commodity, a quantity, a price, a total amount, a received amount, and change.

When a new transaction is performed, the POS device acquires first information from an issued receipt being previously issued. Then, the POS device updates the first information, based on a payment amount of the new transaction. Subsequently, the POS device prints the updated first information on a receipt on which new transaction information is printed.

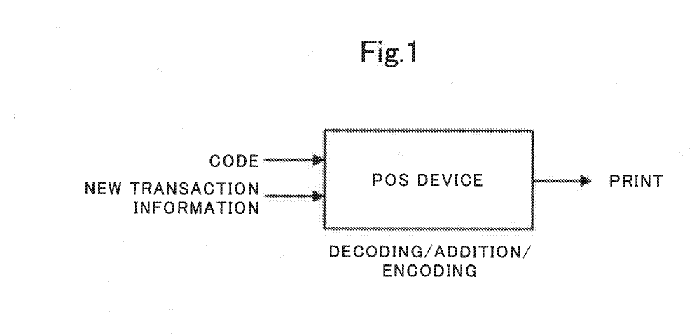

FIG. 1 illustrates an example of an overview of input-output and arithmetic processing of the POS device according to the present example embodiment. As illustrated, a code and new transaction information are input to the POS device.

The new transaction information is information indicating details (e.g. identification information, a price, and a quantity) of a transaction target (e.g. an article or a service). For example, new transaction information is input by an operator operating the POS device and causing the POS device to read a bar code attached to a commodity, or operating an operation button, touch panel, or the like equipped on the POS device. Then, based on the input new transaction information, the POS device executes the checkout processing and the like. Consequently, a payment amount of the new transaction is calculated.

For example, the code is a two-dimensional code (e.g. a QR code [registered trademark]). The code indicates first information including at least one of a totalized amount obtained by totalizing payment amounts of transactions up to that point and a balance amount obtained by subtracting the totalized amount from a target amount being a lower limit for receiving a predetermined service. For example, the predetermined service includes a discount service and a free service. The code is printed on an issued receipt.

Unless otherwise noted, a “code” mentioned below means the aforementioned code. Further, unless otherwise noted, “encoding” mentioned below means converting text information expressed by a character code or the like, numerical value information, and the like into the aforementioned code. Further, unless otherwise noted, “information before encoding” mentioned below means information before being converted into the aforementioned code and includes, for example, text information expressed by a character code or the like, and numerical value information. Further, unless otherwise noted, “decoding (a code)” means converting the aforementioned code into, for example, text information expressed by a character code or the like, and numerical value information.

When performing a new transaction, a customer hands an issued receipt held by the customer to an operator. Then the operator operates the POS device and causes the POS device to read a code printed on the received receipt. Consequently, input of the code to the POS device is provided.

The POS device decodes the input code. Consequently, the POS device obtains first information after decoding. Then, based on a payment amount of the new transaction, the POS device updates the first information after decoding. Specific updates include “adding a payment amount of the new transaction to a totalized amount obtained by totalizing payment amounts of past transactions” or “subtracting the payment amount of the new transaction from a balance amount obtained by subtracting the totalized amount from a target amount being a lower limit for receiving a predetermined service.”

Subsequently, the POS device encodes the updated first information after decoding. Then, the POS device issues a receipt on which a code indicating new transaction information, the updated first information after decoding (information before encoding), and the first information is printed. For example, the new transaction information includes a transaction date and time, a store name, a purchased commodity, a quantity, a price, a total amount, a received amount, and change.

Each time a service user shops at a store participating in a service, the service user presents a most recent receipt to the store and has a code read. Then, based on a transaction at the store, the service user receives a new receipt on which updated first information (including a code and information before encoding) is printed.

The present example embodiment as described above enables an easy grasp of a total of respective payment amounts at a plurality of stores and a balance amount with respect to a predetermined value, by referring to a receipt. Further, in the case of the present example embodiment, first information is printed on a receipt indicating transaction information, and therefore a dedicated medium for printing the first information does not need to be newly prepared. Accordingly, a burden of costs can be reduced. Further, inconvenience due to increase in a number of articles managed by a customer can be avoided.

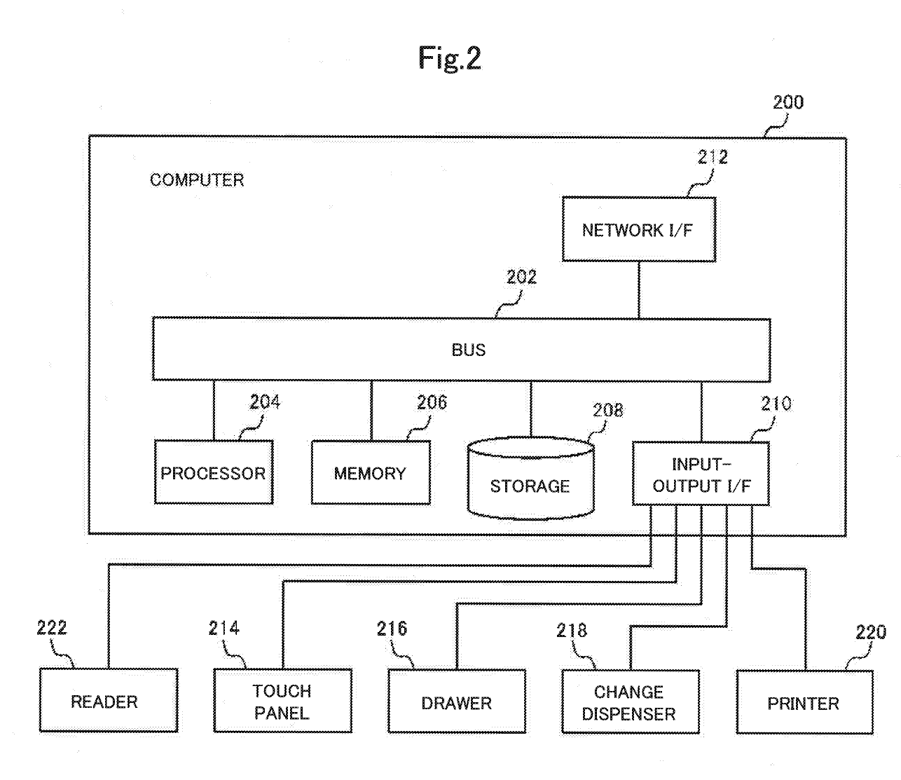

Next, a hardware configuration of the POS device according to the present example embodiment will be described. FIG. 2 illustrates a hardware configuration example of the POS device according to the present example embodiment. The POS device includes a computer 200, a touch panel 214, a drawer 216, a change dispenser 218, a printer 220, and a reader 222. The POS device may include another component.

The computer 200 includes a bus 202, a processor 204, a memory 206, a storage 208, an input-output interface 210, and a network interface 212. The bus 202 is a data transmission line for the processor 204, the memory 206, the storage 208, the input-output interface 210, and the network interface 212 to mutually transmit and receive data. However, the method of mutually connecting the processor 204 and another component is not limited to the bus connection.

The processor 204 includes arithmetic processing units such as a central processing unit (CPU) and a graphics processing unit (GPU). The memory 206 includes memories such as a random access memory (RAM) and a read only memory (ROM). The storage 208 includes storage devices such as a hard disk, a solid state drive (SSD), and a memory card. Further, the storage 208 may include memories such as a RAM and a ROM.

The input-output interface 210 is an interface for connecting the computer 200 to an input-output device. In FIG. 2, the touch panel 214 and the reader 222 are connected to the input-output interface 210. The computer 200 may be connected to another input interface such as a keyboard.

The touch panel 214 accepts input for an operator to operate the computer 200. For example, the touch panel 214 is used for manually inputting a price of a commodity and registering a commodity (transaction target) not attached with a bar code. Additionally, the touch panel 214 displays various types of information such as information about a commodity registered as a transaction target.

The reader 222 accepts input of various codes. For example, the reader 222 reads a bar code attached to a commodity, a code (e.g. a two-dimensional code such as a QR code [registered trademark]) attached to a receipt, and the like.

The network interface 212 is an interface for communicably connecting the computer 200 to an external device. The network interface 212 may be a network interface for connecting to a wired line or may be a network interface for connecting to a wireless line.

The storage 208 stores program modules for providing respective functions of the POS device. By executing the program modules, the processor 204 provides respective functions related to the program modules. When executing each of the aforementioned modules, the processor 204 may read the module into the memory 206 before execution or may execute the module without reading the module into the memory 206.

The drawer 216 stores a coin, a bill, and the like. The change dispenser 218 has a slot for a customer to insert a payment and an outlet for ejecting change. The printer 220 issues a receipt and the like.

The hardware configuration of the computer 200 is not limited to the configuration illustrated in FIG. 2. For example, each program module may be stored in the memory 206. In this case, the computer 200 may not include the storage 208.

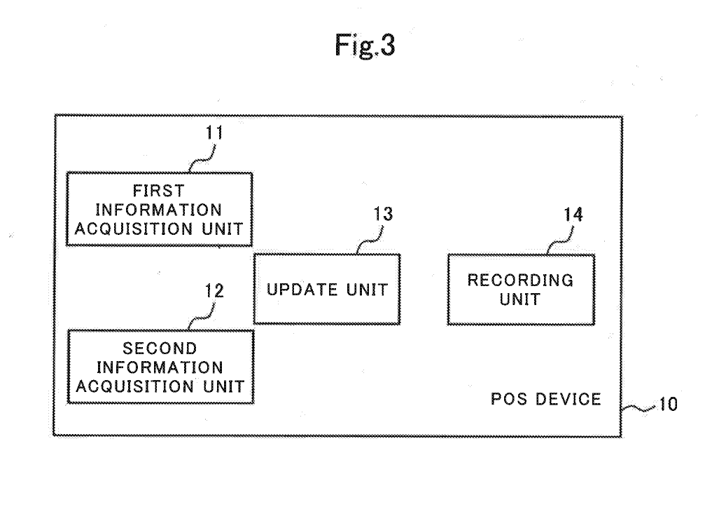

Next, FIG. 3 illustrates an example of a functional block diagram of the POS device 10 according to the present example embodiment. As illustrated, the POS device 10 includes a first information acquisition unit 11, a second information acquisition unit 12, an update unit 13, and a recording unit 14.

Note that the functional block diagram in FIG. 3 represents a block based on a functional unit rather than a configuration based on a hardware unit. Each functional unit may be provided by hardware (e.g. a hardwired electronic circuit) or may be provided by a combination of hardware and software (e.g. a combination of an electronic circuit and a program controlling the circuit). Further, while FIG. 3 illustrates the POS device 10 to be provided by one piece of equipment, the means for providing the POS device is not limited thereto. In other words, the POS device may have a physically separated configuration or a logically separated configuration. A same reference sign is hereinafter given to a same component, and description thereof is omitted as appropriate. The assumptions described above similarly apply to every example embodiment described below.

The first information acquisition unit 11 acquires first information from an issued receipt on which the first information is printed. The first information includes at least one of a totalized amount obtained by totalizing payment amounts of past transactions and a balance amount obtained by subtracting the aforementioned totalized amount from a target amount being a lower limit for receiving a predetermined service.

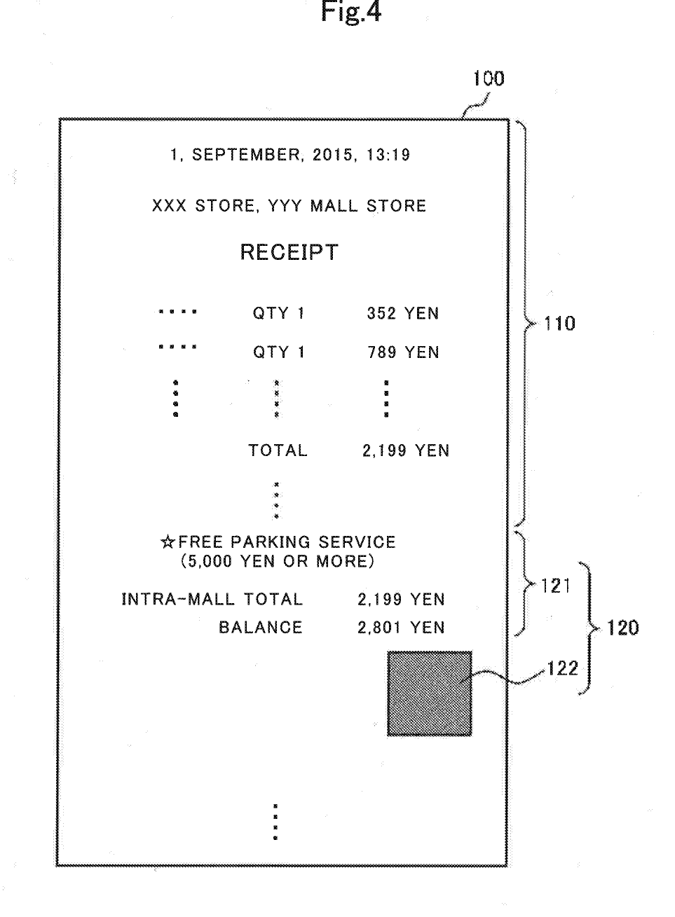

FIG. 4 schematically illustrates an example of an issued receipt 100. Transaction information 110 and first information 120 are printed on the receipt 100. The transaction information 110 includes transaction details, that is, a store name, a transaction date and time, a name of a transaction target (e.g. an article or a service), a quantity, an amount, a total amount, a received amount, and a change amount.

As described above, the first information 120 includes at least one of a totalized amount obtained by totalizing payment amounts of past transactions and a balance amount obtained by subtracting the aforementioned totalized amount from a target amount being a lower limit for receiving a predetermined service. In the case of the illustrated example, an amount corresponding to an “intra-mall total” indicates a totalized amount obtained by totalizing payment amounts of past transactions. Then, an amount corresponding to a “balance” indicates a balance amount obtained by subtracting the aforementioned totalized amount from a target amount being a lower limit for receiving a predetermined service.

The first information 120 printed on the receipt 100 includes a code 122 and information before encoding 121.

The first information acquisition unit 11 includes a reader for reading the code 122. Then, the first information acquisition unit 11 accepts input of the code 122 through the reader. The first information acquisition unit 11 according to the present example embodiment may further execute processing of decoding the code 122 input of which is accepted.

Returning to FIG. 3, the second information acquisition unit 12 acquires a payment amount of a new transaction. For example, an operator operates the reader in the POS device 10 and causes the reader to read a bar code attached to a commodity and operates an operation button, a touch panel, and the like equipped on the POS device 10. Thus, registration of a transaction target (e.g. an article or a service), checkout processing, and the like are executed. Consequently, a payment amount of the new transaction is calculated. The second information acquisition unit 12 acquires the thus calculated payment amount of the new transaction.

Based on a payment amount of a new transaction acquired by the second information acquisition unit 12, the update unit 13 updates first information acquired by the first information acquisition unit 11. Specifically, the update unit 13 updates the first information. The update includes “adding a payment amount of a new transaction to a totalized amount obtained by totalizing payment amounts of past transactions” or “subtracting the payment amount of the new transaction from a balance amount obtained by subtracting the totalized amount from a target amount being a lower limit for receiving a predetermined service.” The update unit 13 according to the present example embodiment may encode the updated first information.

The recording unit 14 prints updated first information on a newly-issued receipt on which new transaction information is printed. In other words, the recording unit 14 issues a receipt on which the new transaction information and the updated first information are printed. The updated first information to be printed includes a code and information before encoding.

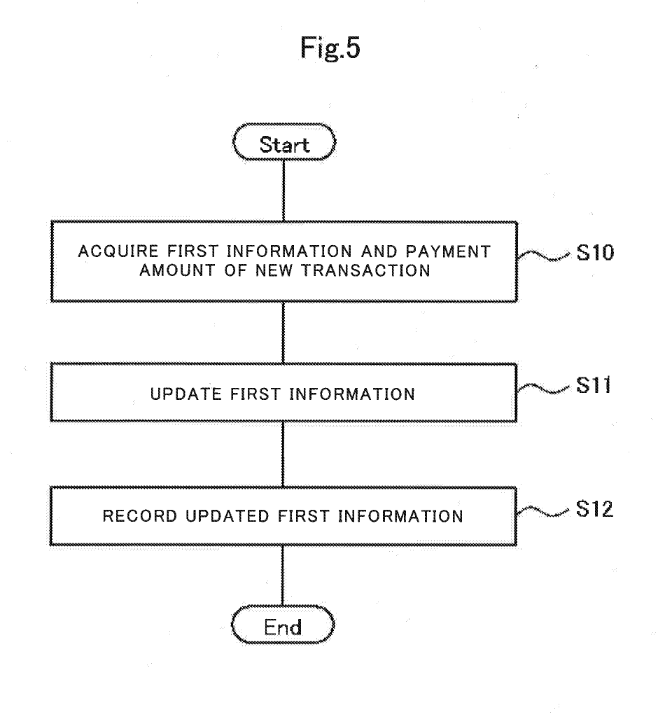

Next, using a flowchart in FIG. 5, an example of a processing flow in the POS device 10 according to the present example embodiment will be described.

First, the first information acquisition unit 11 and the second information acquisition unit 12 acquire first information and a payment amount of a new transaction (S10).

Then, based on the payment amount of the new transaction, the update unit 13 updates the first information (S11).

Subsequently, the recording unit 14 prints the updated first information on a newly-issued receipt on which new transaction information is printed (S12).

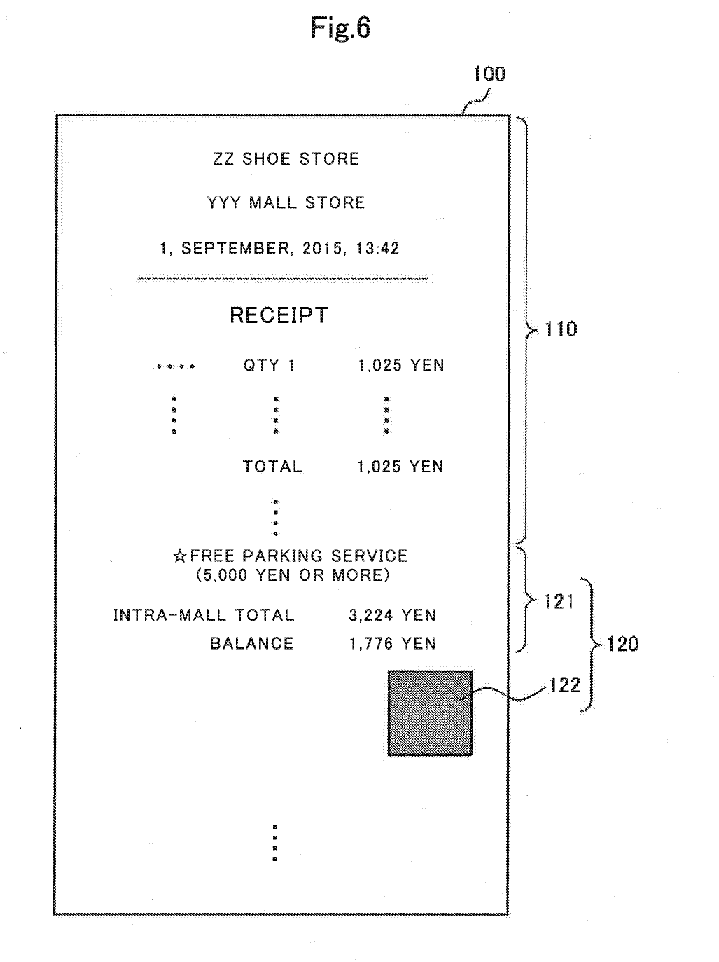

For example, in S10, the first information acquisition unit 11 acquires the first information by reading the code 122 on the receipt 100 illustrated in FIG. 4. Then, in S12, the recording unit 14 issues a receipt 100 as illustrated in FIG. 6. By referring to the first information 120 on the receipt 100 in FIG. 4, and transaction information 110 and first information 120 on the newly issued receipt 100 in FIG. 6, it is understood that the first information 120 is updated based on a transaction indicated in the transaction information 110 on the receipt 100 in FIG. 6.

According to the present example embodiment described above, each time shopping is performed at a store, most recent status of a total of respective payment amounts at a plurality of stores and a balance amount with respect to a predetermined value is printed on a receipt issued at the store. Checking such a receipt enables an easy grasp of the total of the respective payment amounts at the plurality of stores and the balance amount with respect to the predetermined value.

Further, in the case of the present example embodiment, first information is printed on a receipt indicating transaction information, and therefore a medium for printing the first information does not need to be newly prepared. Accordingly, a burden of costs can be reduced. Further, inconvenience due to increase in a number of articles managed by a customer can be avoided.

### Second Example Embodiment

An information processing device according to the present example embodiment executes processing similar to that executed by the POS device 10 according to the first example embodiment. The information processing device according to the present example embodiment is an attached device retrofitted to a POS device.

For example, the attached device according to the present example embodiment is used at a store such as a retail store. The attached device is suitable for use at a store participating in a service offering a predetermined service (e.g. a discount service or a free service) when a total payment amount at one or more predetermined stores exceeds a predetermined value.

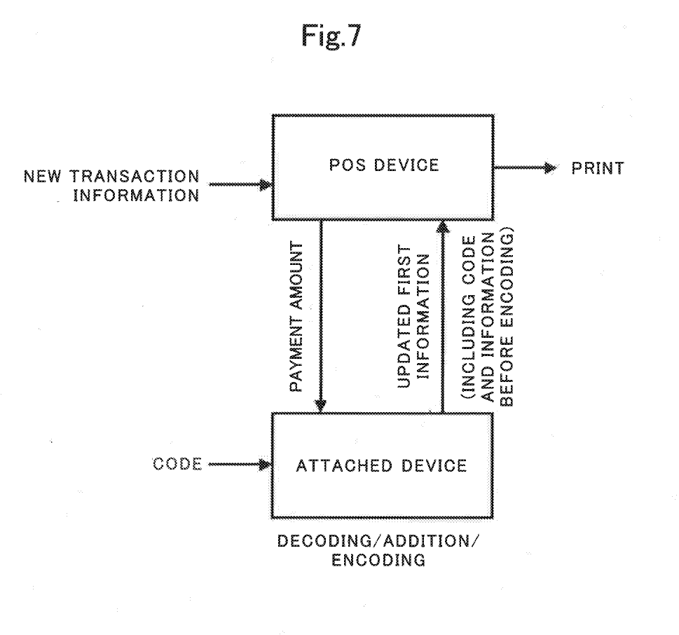

FIG. 7 illustrates an example of an overview of input-output and arithmetic processing of the information processing device (attached device) according to the present example embodiment. As illustrated, the information processing device (attached device) according to the present example embodiment is connected to a POS device, transmits and receives information to and from the POS device, and executes predetermined processing in cooperation with the POS device. The connection method between the attached device and the POS device is not restricted. The devices may be connected through a wired line or may be connected through a wireless line. For example, the attached device and the POS device are connected on a one-to-one basis.

New transaction information is input to the POS device. The new transaction information is described in the first example embodiment, and therefore description thereof is omitted here. Based on the input new transaction information, the POS device executes checkout processing and the like. Consequently, a payment amount of the new transaction is calculated.

A code and a payment amount of a new transaction are input to the attached device. The payment amount of the new transaction is input from the POS device to the attached device. The code is described in the first example embodiment, and therefore description thereof is omitted here. For example, the attached device includes a reader for reading a code. Then, input of the code is provided by an operator operating the attached device and causing the attached device to read the code printed on a receipt.

The attached device decodes the input code. Then, based on the payment amount of the new transaction, the attached device updates first information after decoding. Specific updates include “adding a payment amount of a new transaction to a totalized amount obtained by totalizing payment amounts of past transactions” or “subtracting the payment amount of the new transaction from a balance amount obtained by subtracting the totalized amount from a target amount being a lower limit for receiving a predetermined service.”

Subsequently, the attached device encodes the updated first information after decoding. Then, the attached device transmits the updated first information (including a code and the information before encoding) to the POS device.

Then, the POS device issues a receipt on which new transaction information (a transaction statement such as a transaction date and time, a store name, a purchased commodity, a quantity, a price, a total amount, a received amount, and change) and the updated first information (including the code and the information before encoding) are printed.

The present example embodiment as described above is able to provide an operation and effect similar to that provided by the first example embodiment.

Next, a hardware configuration of the information processing device (attached device) according to the present example embodiment will be described.

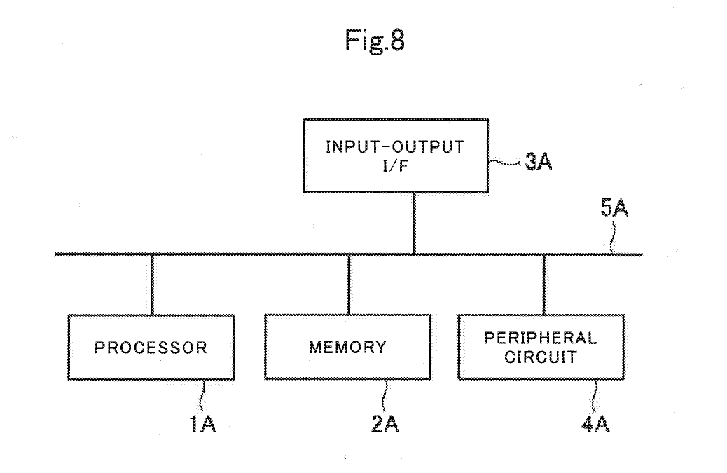

FIG. 8 illustrates a hardware configuration example of the information processing device according to the present example embodiment. As illustrated, the information processing device includes a processor 1A, a memory 2A, an input-output interface 3A, a peripheral circuit 4A, and a bus 5A. The peripheral circuit includes various modules.

The bus 5A is a data transmission line for the processor 1A, the memory 2A, the peripheral circuit 4A, and the input-output interface 3A to mutually transmit and receive data. For example, the processor 1A includes arithmetic processing units such as a CPU and GPU. For example, the memory 2A includes memories such as a RAM and a ROM. The input-output interface 3A includes an interface for transmitting and receiving information to and from devices such as a sensor and a remote control terminal. The processor 1A issues an instruction to each module and performs an operation, based on the operation result of the instruction.

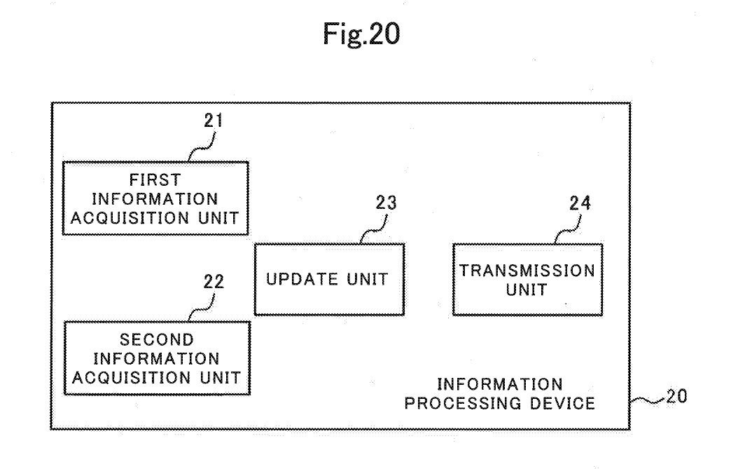

FIG. 20 illustrates an example of a functional block diagram of the information processing device (attached device) 20 according to the present example embodiment. As illustrated, the information processing device 20 includes a first information acquisition unit 21, a second information acquisition unit 22, an update unit 23, and a transmission unit 24.

A configuration of the first information acquisition unit 21 is similar to the configuration of the first information acquisition unit 21 described in the first example embodiment. The first information acquisition unit 21 according to the present example embodiment acquires first information directly from an issued receipt. Specifically, the first information acquisition unit 21 includes a reader and acquires first information by reading a code printed on an issued receipt.

The second information acquisition unit 22 differs from the second information acquisition unit 12 described in the first example embodiment in acquiring a payment amount of a new transaction from the POS device. The remaining configuration is similar to that of the second information acquisition unit 12.

A configuration of the update unit 23 is similar to the configuration of the update unit 13 described in the first example embodiment.

The transmission unit 24 transmits updated first information (including a code and information before encoding) to the POS device.

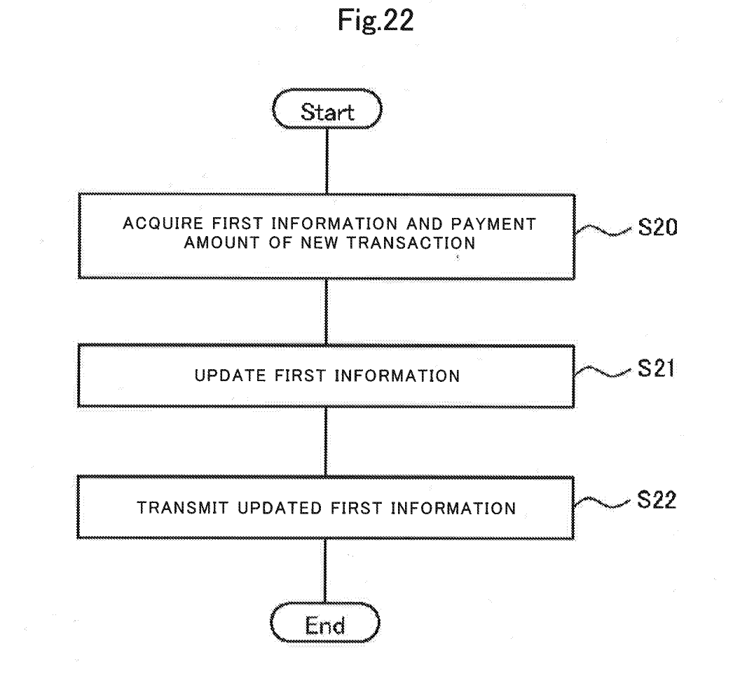

Next, using a flowchart in FIG. 22, an example of a processing flow in the information processing device 20 according to the present example embodiment will be described.

In S20, the first information acquisition unit 21 acquires first information directly from an issued receipt. Further, the second information acquisition unit 22 acquires a payment amount of a new transaction from the POS device.

In S21, based on the payment amount of the new transaction, the update unit 23 updates the first information.

In S22, the transmission unit 24 transmits the updated first information to the POS device. Then, the POS device prints the updated first information received from the information processing device 20 on a newly-issued receipt on which new transaction information is printed.

The present example embodiment as described above is able to provide an operation and effect similar to that provided by the first example embodiment. Further, the aforementioned operation and effect is provided by connecting the attached device (information processing device 20) to an existing POS device and causing the devices to cooperate with one another. Accordingly, a burden of equipment investment can be reduced compared with a case of newly introducing a POS device 10 with the function described in the first example embodiment, the device providing the aforementioned operation and effect.

### Third Example Embodiment

An information processing device 20 according to the present example embodiment is an attached device, similarly to that according to the second example embodiment. Part of details of processing executed by the attached device according to the present example embodiment differs from those executed by the attached device according to the second example embodiment.

For example, the attached device according to the present example embodiment is used at a store such as a retail store. The attached device is suitable for use at a store participating in a service offering a predetermined service (e.g. a discount service or a free service) when a total payment amount at one or more predetermined stores exceeds a predetermined value.

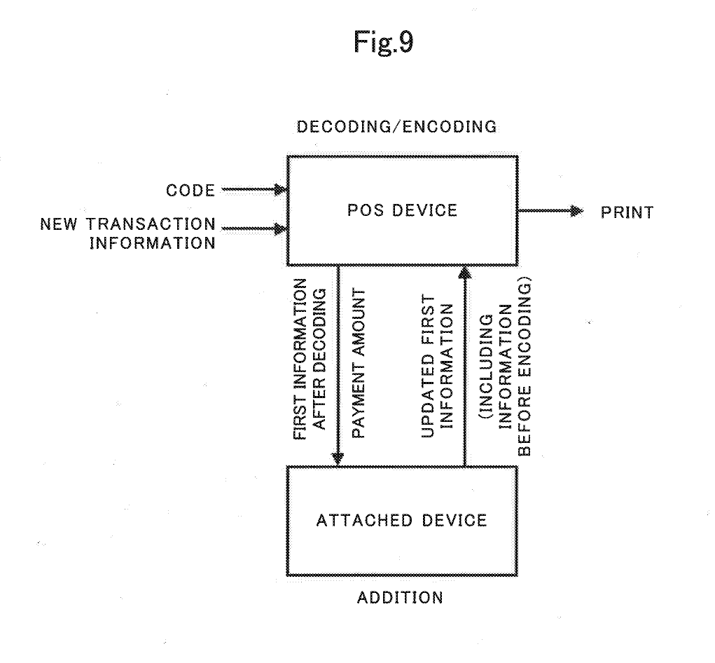

FIG. 9 illustrates an example of an overview of input-output and arithmetic processing of the attached device according to the present example embodiment. As illustrated, the attached device according to the present example embodiment is connected to a POS device, transmits and receives information to and from the POS device, and executes predetermined processing in cooperation with the POS device. The connection method between the attached device and the POS device is not restricted. The devices may be connected through a wired line or connected through a wireless line. For example, the attached device and the POS device are connected on a one-to-one basis.

A code and new transaction information are input to the POS device. The code is described in the first example embodiment, and therefore description thereof is omitted here. For example, input of the code is provided by an operator operating the POS device and causing the POS device to read the code printed on a receipt. When the code is input, the POS device decodes the code.

The new transaction information is described in the first example embodiment, and therefore description thereof is omitted here. Based on the input new transaction information, the POS device executes checkout processing and the like. Consequently, a payment amount of the new transaction is calculated.

Decoded first information and the payment amount of the new transaction are input from the POS device to the attached device. Then, based on the payment amount of the new transaction, the attached device updates the first information. Subsequently, the attached device transmits the updated first information to the POS device.

Then, the POS device encodes the updated first information. Then, the POS device issues a receipt on which the new transaction information and the updated first information (including a code and the information before encoding) are printed.

The present example embodiment as described above is able to provide an operation and effect similar to that provided by the first and second example embodiments.

A hardware configuration of the information processing device (attached device) according to the present example embodiment is illustrated in FIG. 8, similarly to that according to the second example embodiment. Details thereof are described in the second example embodiment, and therefore description thereof is omitted here.

An example of a functional block diagram of the information processing device (attached device) 10 according to the present example embodiment is illustrated in FIG. 20, similarly to that according to the second example embodiment. As illustrated, the information processing device 20 includes a first information acquisition unit 21, a second information acquisition unit 22, an update unit 23, and a transmission unit 24.

A configuration of the update unit 23 is similar to that of the update unit 23 according to the second example embodiment. Further, a configuration of the second information acquisition unit 22 is similar to that of the second information acquisition unit 22 according to the second example embodiment.

The first information acquisition unit 21 differs from the first information acquisition unit 21 according to the second example embodiment in acquiring first information from the POS device. The POS device according to the present example embodiment transmits first information (information after decoding) acquired from an issued receipt to the first information acquisition unit 21. The remaining configuration of the first information acquisition unit 21 is similar to the first information acquisition unit 11 according to the second example embodiment.

The transmission unit 24 transmits updated first information (information before encoding) to the POS device. A recording unit in the POS device encodes the received updated first information and prints the updated first information including a code and the information before encoding on a receipt.

The present example embodiment as described above is able to provide an operation and effect similar to that provided by the first and second example embodiments.

### Fourth Example Embodiment

An information processing device 20 according to the present example embodiment is an attached device, similarly to that according to the second and third example embodiments. Part of details of processing executed by the attached device according to the present example embodiment differs from those executed by the attached device according to the second and third example embodiments.

For example, the attached device according to the present example embodiment is used at a store such as a retail store. The attached device is suitable for use at a store participating in a service offering a predetermined service (e.g. a discount service or a free service) when a total payment amount at one or more predetermined stores exceeds a predetermined value.

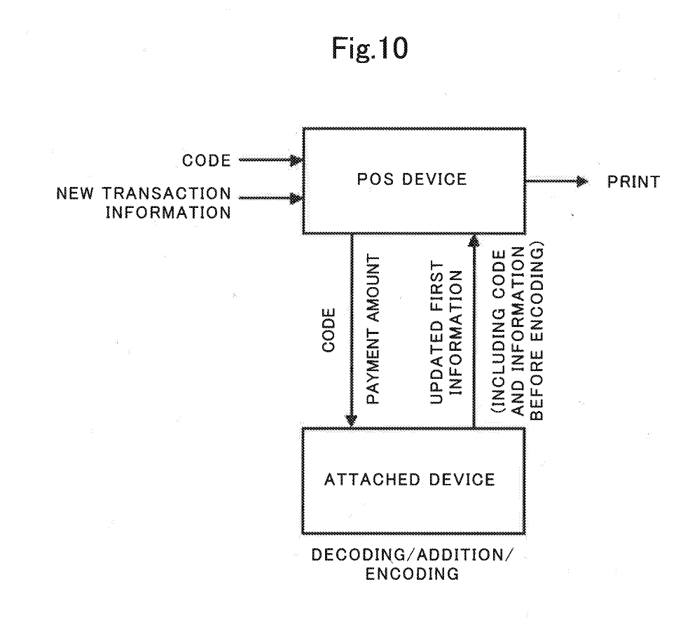

FIG. 10 illustrates an example of an overview of input-output and arithmetic processing of the attached device according to the present example embodiment. As illustrated, the information processing device (attached device) according to the present example embodiment is connected to a POS device, transmits and receives information to and from the POS device, and executes predetermined processing in cooperation with the POS device. The connection method between the attached device and the POS device is not restricted. The devices may be connected through a wired line or may be connected through a wireless line. For example, the attached device and the POS device are connected on a one-to-one basis.

A code and new transaction information are input to the POS device. The code is described in the first example embodiment, and therefore description thereof is omitted here. For example, input of the code is provided by an operator operating the POS device and causing the POS device to read the code printed on a receipt.

The new transaction information is described in the first example embodiment, and therefore description thereof is omitted here. Based on the input new transaction information, the POS device executes checkout processing and the like. Consequently, a payment amount of the new transaction is calculated.

A code of first information and the payment amount of the new transaction are input from the POS device to the attached device. Then, the attached device decodes the code of the first information. Then, based on the payment amount of the new transaction, the attached device updates the first information after decoding. Subsequently, the attached device encodes the updated first information after decoding. Then, the attached device transmits the updated first information (including a code and the information before encoding) to the POS device.

Then, the POS device issues a receipt on which the new transaction information and the updated first information (including the code and the information before encoding) are printed.

The present example embodiment as described above is able to provide an operation and effect similar to that provided by the first to third example embodiments.

A hardware configuration of the information processing device (attached device) according to the present example embodiment is illustrated in FIG. 8, similarly to that according to the second and third example embodiments. Details thereof are described in the second example embodiment, and therefore description thereof is omitted here.

An example of a functional block diagram of the information processing device (attached device) 20 according to the present example embodiment is illustrated in FIG. 20, similarly to that according to the second and third example embodiments. As illustrated, the information processing device 20 includes a first information acquisition unit 21, a second information acquisition unit 22, an update unit 23, and a transmission unit 24.

A configuration of the update unit 23 is similar to that of the update unit 23 according to the second and third example embodiments. Further, a configuration of the second information acquisition unit 22 is similar to that of the second information acquisition unit 22 according to the second and third example embodiments.

A configuration of the first information acquisition unit 21 is similar to that of the first information acquisition unit according to the third example embodiment.

The transmission unit 24 transmits updated first information (a code and information before encoding) to the POS device. For example, the transmission unit 24 may perform encoding. A recording unit in the POS device prints the received updated first information (including the code and the information before encoding) on a receipt.

The present example embodiment as described above is able to provide an operation and effect similar to that provided by the first to third example embodiments.

### Fifth Example Embodiment

A POS device 10 and an information processing device 20, according to the present example embodiment, differ from those according to the first to fourth example embodiments in, when acquiring first information and a payment amount of a new transaction, determining whether or not to update the first information, based on the payment amount of the new transaction, and when determining to perform the update, updating the information. The remaining configuration is similar to that according to the first to fourth example embodiments.

A hardware configuration of the POS device 10 according to the present example embodiment is illustrated in FIG. 2, similarly to that according to the first example embodiment. Further, a hardware configuration of the information processing device 20 according to the present example embodiment is illustrated in FIG. 8, similarly to that according to the second to fourth example embodiments.

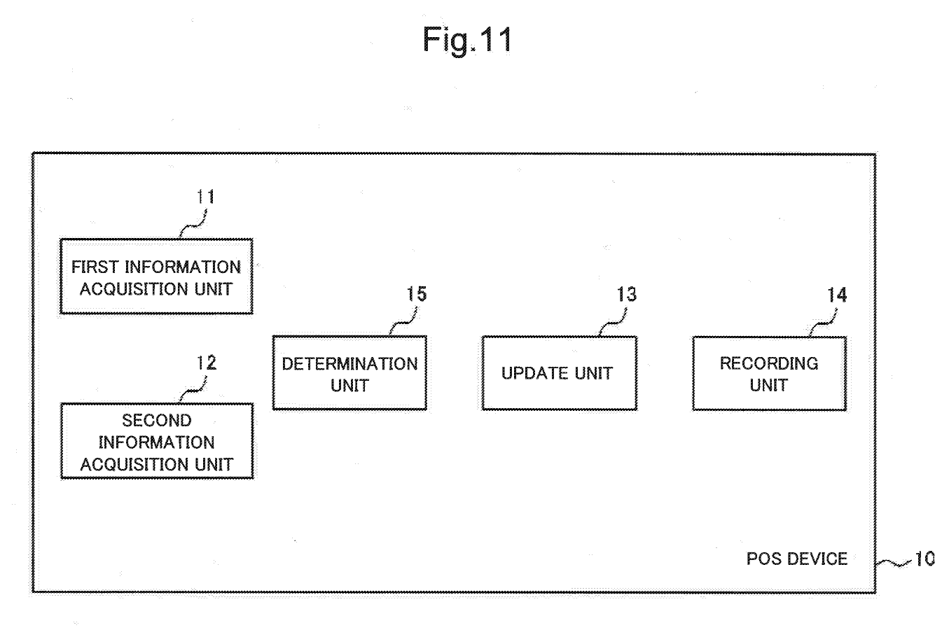

FIG. 11 illustrates an example of a functional block diagram of the POS device 10 according to the present example embodiment. As illustrated, the POS device 10 includes a first information acquisition unit 11, a second information acquisition unit 12, an update unit 13, a recording unit 14, and a determination unit 15. Configurations of the first information acquisition unit 11 and the second information acquisition unit 12 are similar to those according to the first example embodiment.

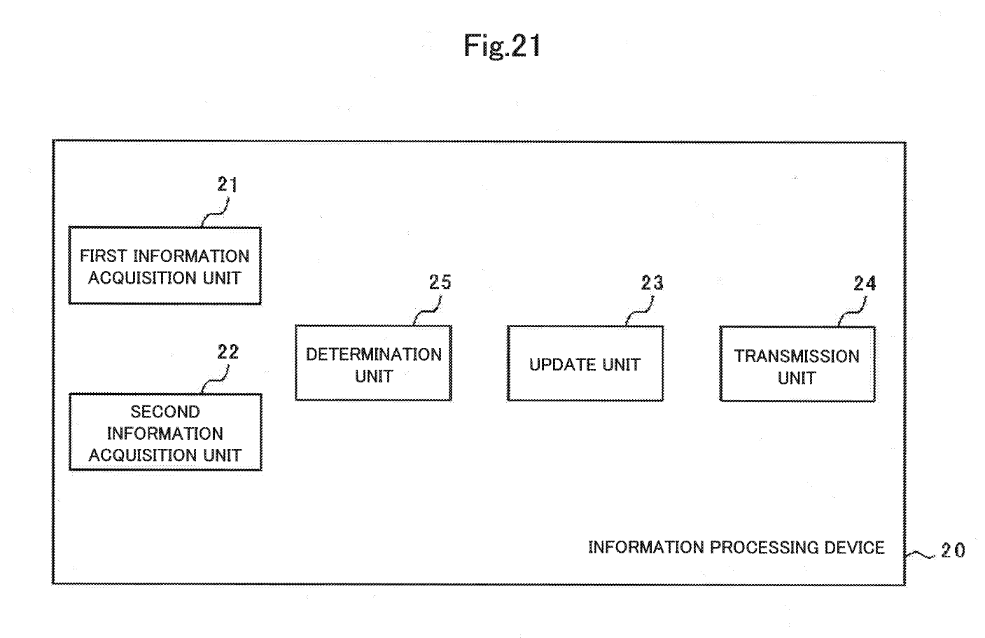

FIG. 21 illustrates an example of a functional block diagram of the information processing device 20 according to the present example embodiment. As illustrated, the information processing device 20 includes a first information acquisition unit 21, a second information acquisition unit 22, an update unit 23, a transmission unit 24, and a determination unit 25. Configurations of the first information acquisition unit 21 and the second information acquisition unit 22 are similar to those according to the second to fourth example embodiments.

The determination unit 15/25 determines whether to update first information, based on a payment amount of a new transaction. Then, when the determination unit 15/25 determines to perform the update, the update unit 13/23 updates the first information, based on the payment amount of the new transaction. On the other hand, when the determination unit 15/25 determines not to perform the update, the update unit 13/23 does not update the first information, based on the payment amount of the new transaction.

When the first information is updated, the recording unit 14 in FIG. 11 prints the updated first information on a receipt. Further, the transmission unit 24 in FIG. 21 transmits the updated first information to the POS device.

On the other hand, when the first information is not updated, the recording unit 14 in FIG. 11 may print the first information before update on a receipt. Alternatively, when the first information is not updated, the recording unit 14 in FIG. 11 may print on a receipt first information solely based on the new transaction details. Further, the transmission unit 24 in FIG. 21 may transmit the first information before update to the POS device.

Specific examples according to the present example embodiment will be described below. The POS device 10 and the information processing device 20, according to the present example embodiment, may execute at least one of the specific examples.

### Specific Example 1

In this example, information indicating an expiration date is further included in first information. Then, when acquiring the first information from the first information acquisition unit 11/21, the determination unit 15/25 determines whether the expiration date is reached. When the expiration date is reached, the determination unit 15/25 determines not to perform an update. On the other hand, when the expiration date is not reached, the determination unit 15/25 determines to perform an update.

When the determination unit 15/25 determines not to perform an update in the specific example 1, the recording unit 14 in FIG. 11 discards the expired first information acquired by the first information acquisition unit 11. Then, the recording unit 14 may print on a receipt new first information (including a code and information before encoding) solely based on new transaction details. Further, the transmission unit 24 in FIG. 21 may transmit the new first information solely based on the new transaction details to the POS device.

### Specific Example 2

A case that a plurality of services are performed in parallel, each service offering a predetermined service when a total payment amount at one or more predetermined stores exceeds a predetermined value, may be considered. Additionally, a case that all stores do not necessarily participate in all services, and participation status varies from one store to another may be considered.

An example that a service offering free parking when a total payment amount exceeds 5000 yen in a mall and a service giving a cup of shaved ice when a total payment amount exceeds 3000 yen in the mall are offered concurrently may be considered. The former is also referred to as a parking service, and the latter is also referred to as a shaved ice service.

Furthermore, an example that, while a store A participates in the parking service and the shaved ice service, a store B participates in the parking service and does not participate in the shaved ice service may be considered. In the case of this example, while shopping at the store A contributes to the parking service and the shaved ice service, shopping at the store B contributes to the parking service and does not contribute to the shaved ice service.

The specific example 2 is based on such assumptions.

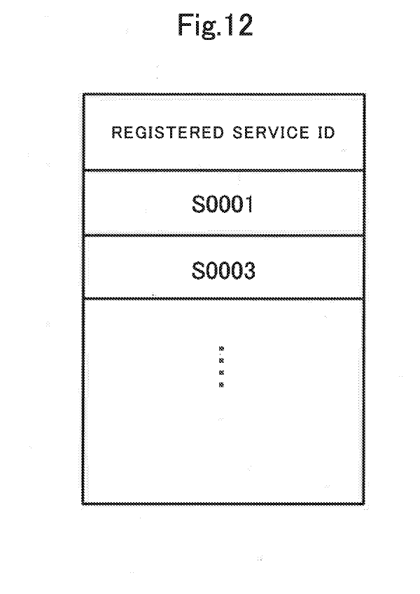

The determination unit 15/25 retains a list of services in which the respective stores participate. FIG. 12 schematically illustrates an example of the list. For example, an operator at each store operates a POS device or an information processing device 20 in the store and registers a service in which the store participates. A list as illustrated in FIG. 12 is registered in the determination unit 15/25 by the operation.

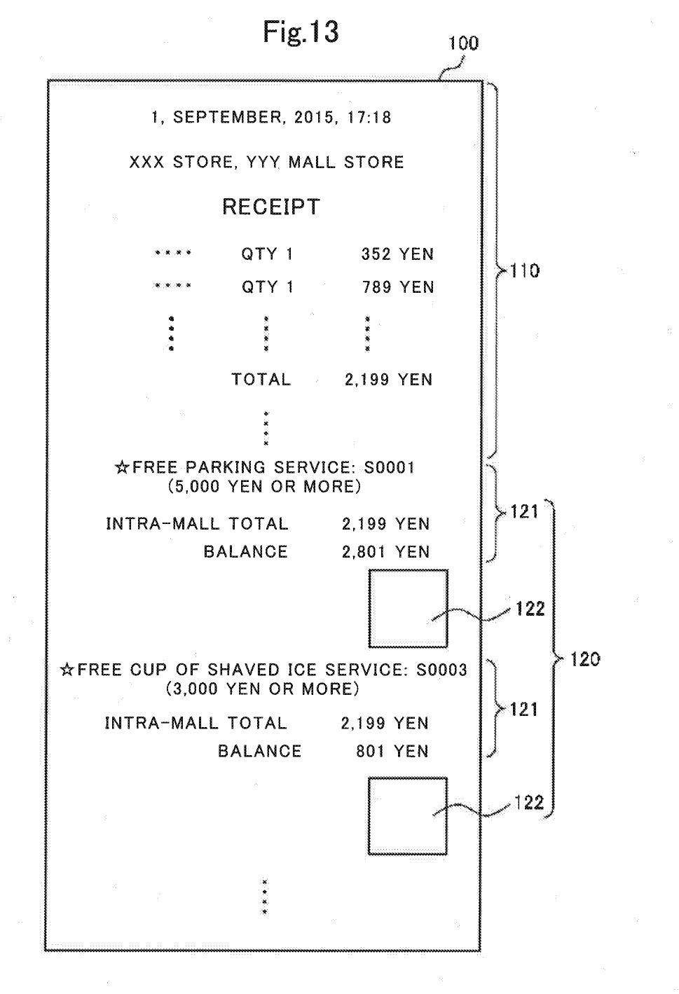

In this specific example, first information is generated for each service. Then, as illustrated in FIG. 13, a plurality of pieces of first information are printed on a receipt. The first information further includes service identification information for identifying a related service.

The first information acquisition unit 11/21 is able to acquire a plurality of pieces of first information. When acquiring first information from the first information acquisition unit 11/21, the determination unit 15/25 acquires service identification information included in each piece of first information. Then, the determination unit 15/25 refers to the list of services in which the store participates and checks whether the service identification information acquired from each piece of first information is included in the list. When the information is included, that is, the store performing a new transaction participates in the service, the determination unit 15/25 determines to perform an update. On the other hand, when the information is not included, that is, the store performing the new transaction does not participate in the service, the determination unit 15/25 determines not to perform an update.

When the first information acquisition unit 11/21 acquires a plurality of pieces of first information, the determination unit 15/25 determines whether or not to perform an update for each piece of first information.

When the determination unit 15/25 determines not to perform an update in the specific example 2, the recording unit 14 in FIG. 11 may print the first information before update (including a code and information before encoding) on a receipt. Further, the transmission unit 24 in FIG. 21 may transmit the first information before update to the POS device.

### Specific Example 3

A case that a plurality of services are performed in parallel, each service offering a predetermined service when a total payment amount at one or more predetermined stores exceeds a predetermined value, may be considered. Additionally, a case that one or more stores form a group and offer a service for each group may be considered.

An example that a first group including a store A, a store B, and a store C offers a certain service, and a second group including the store A and a store D offers another service may be considered. For example, the former is a service offering free parking when a total payment amount in the group exceeds 5000 yen, and the latter is a service giving a cup of shaved ice when a total payment amount in the group exceeds 3000 yen.

In such a case, while shopping at the store A contributes to the parking service and the shaved ice service, shopping at the store B contributes to the parking service and does not contribute to the shaved ice service.

The specific example 3 is based on such assumptions.

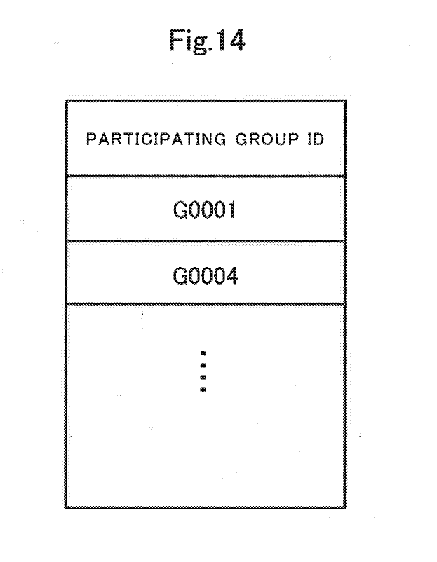

The determination unit 15/25 retains a list of groups to which the respective stores belong. FIG. 14 schematically illustrates an example of the list. For example, an operator at each store operates a POS device 10 or an information processing device 20 in the store and registers a group to which the store belongs. A list as illustrated in FIG. 14 is registered in the determination unit 15/25 by the operation.

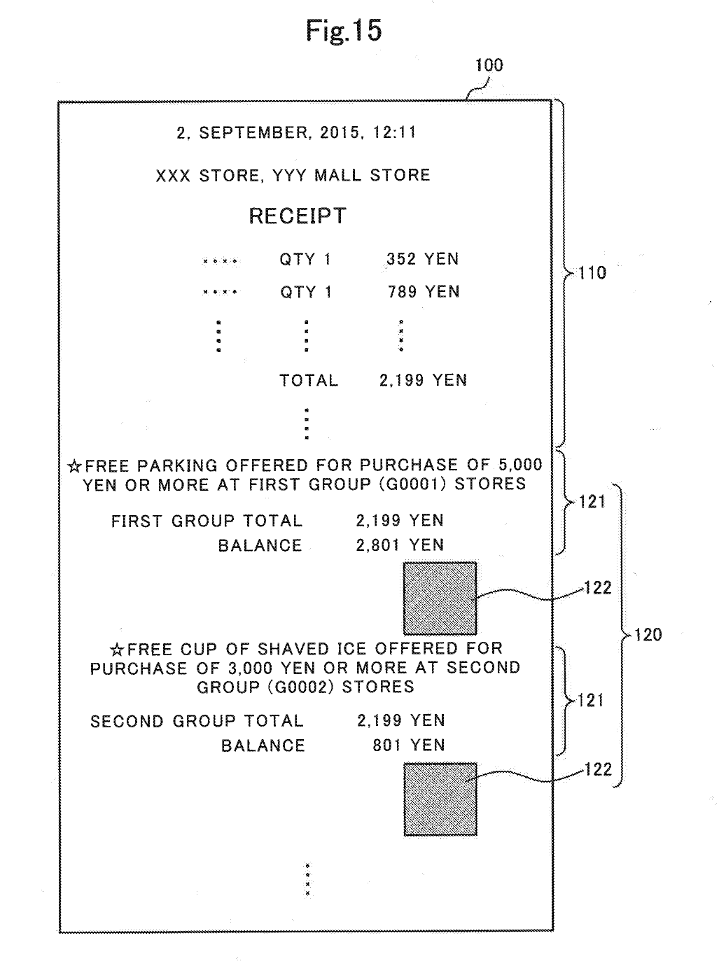

In this specific example, first information is generated for each group. Then, as illustrated in FIG. 15, a plurality of pieces of first information are printed on a receipt. The first information further includes group identification information for identifying a related group.

The first information acquisition unit 11/21 is able to acquire a plurality of pieces of first information. When acquiring first information from the first information acquisition unit 11/21, the determination unit 15/25 acquires group identification information included in each piece of first information. Then, the determination unit 15/25 refers to the list of groups to which the store belongs and checks whether the group identification information acquired from each piece of first information is included in the list. When the information is included, that is, the store performing the new transaction belongs to the group, the determination unit 15/25 determines to perform an update. On the other hand, when the information is not included, that is, the store performing the new transaction does not belong to the group, the determination unit 15/25 determines not to perform an update.

When the first information acquisition unit 11/21 acquires a plurality of pieces of first information, the determination unit 15/25 determines whether or not to perform an update for each piece of first information.

When the determination unit 15/25 determines not to perform an update in the specific example 3, the recording unit 14 in FIG. 11 may print the first information before update (including a code and information before encoding) on a receipt. Further, the transmission unit 24 in FIG. 21 may transmit the first information before update to the POS device.

The present example embodiment as described above is able to provide an operation and effect similar to that provided by the first to fourth example embodiments. Further, the present example embodiment is able to update only a piece of first information satisfying a predetermined condition, instead of, based on a payment amount of a new transaction, updating every piece of first information.

Accordingly, for example, even when a plurality of services are performed in parallel as described above, and also participation status differs from one store to another, first information can be properly managed. Further, inconvenience of updating an expired piece of first information can be avoided.

### Sixth Example Embodiment

The present example embodiment differs from the second to fifth example embodiments in that the information processing device 20 described in the second to fifth example embodiments is not an attached device but is a server configured to be communicable with a POS device. For example, the server may be installed in an office or the like in each store or may be installed at a center managing a plurality of stores.

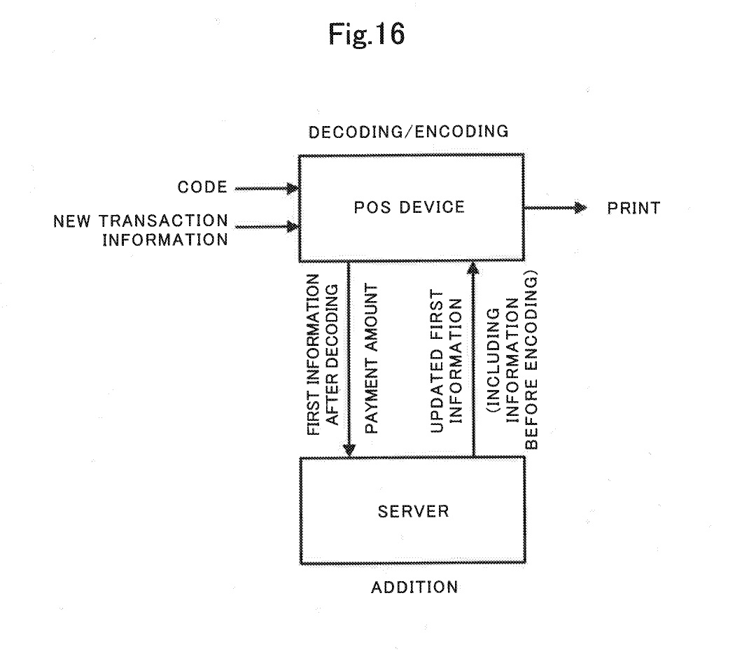

FIG. 16 illustrates an example of an overview of input-output and arithmetic processing of the information processing device (server) according to the present example embodiment. As illustrated, the information processing device (server) according to the present example embodiment is connected to a POS device, transmits and receives information to and from the POS device, and executes predetermined processing in cooperation with the POS device. The connection method between the server and the POS device is not restricted. For example, the devices may be mutually connected through networks such as a local area network (LAN), a wide area network (WAN), the Internet, and a dedicated line. One server may be connected to a plurality of POS devices.

A code and new transaction information are input to the POS device. The code is described in the first example embodiment, and therefore description thereof is omitted here. For example, input of the code is provided by an operator operating the POS device and causing the POS device to read the code printed on a receipt. When the code is input, the POS device decodes the code.

The new transaction information is described in the first example embodiment, and therefore description thereof is omitted here. Based on the input new transaction information, the POS device executes checkout processing and the like. Consequently, a payment amount of the new transaction is calculated.

The server receives the first information after decoding and the payment amount of the new transaction from the POS device. Then, based on the payment amount of the new transaction, the server updates the first information after decoding. Subsequently, the server transmits the updated first information after decoding to the POS device.

Then, the POS device encodes the updated first information after decoding. Then, the POS device issues a receipt on which the new transaction information and the updated first information (including a code and the information before encoding) are printed.

The present example embodiment as described above is able to provide an operation and effect similar to that provided by the first example embodiment.

A hardware configuration of the information processing device (server) according to the present example embodiment is illustrated in FIG. 8, similarly to that according to the second to fifth example embodiments. Details thereof are described in the second example embodiment, and therefore description thereof is omitted here.

An example of a functional block diagram of the information processing device (server) 20 according to the present example embodiment is illustrated in FIG. 20. A configuration of each unit is similar to that according to the third example embodiment.

The present example embodiment as described above is able to provide an operation and effect similar to that provided by the fifth example embodiment. Further, the aforementioned operation and effect is provided by connecting the server (information processing device 20) to an existing POS device and causing the devices to cooperate with one another. Accordingly, a burden of equipment investment can be reduced compared with a case of newly introducing a POS device (the POS device according to the first example embodiment) providing the aforementioned operation and effect.

### Seventh Example Embodiment

An information processing device 20 according to the present example embodiment is a server, similarly to that according to the sixth example embodiment. Part of details of processing executed by the server according to the present example embodiment differs from those executed by the server according to the sixth example embodiment.

For example, the server may be installed in an office or the like in each store or may be installed at a center managing a plurality of stores.

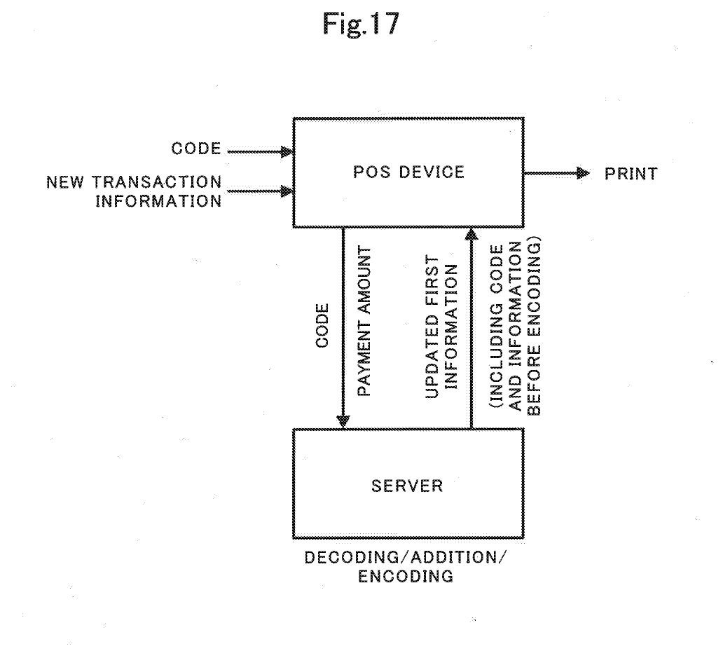

As illustrated in FIG. 17, the information processing device (server) according to the present example embodiment is connected to a POS device, transmits and receives information to and from the POS device, and executes predetermined processing in cooperation with the POS device. The connection method between the server and the POS device is not restricted. For example, the devices may be mutually connected through networks such as a LAN, a WAN, the Internet, and a dedicated line. One server may be connected to a plurality of POS devices.

A code and new transaction information are input to the POS device. The code is described in the first example embodiment, and therefore description thereof is omitted here. For example, input of the code is provided by an operator operating the POS device and causing the POS device to read the code printed on a receipt.

The new transaction information is described in the first example embodiment, and therefore description thereof is omitted here. Based on the input new transaction information, the POS device executes checkout processing and the like. Consequently, a payment amount of the new transaction is calculated.

The server receives a code of first information and the payment amount of the new transaction from the POS device. Then, the server decodes the code of the first information. Then, based on the payment amount of the new transaction, the server updates the first information after decoding. Subsequently, the server encodes the updated first information after decoding. Then, the server transmits the updated first information (including a code and the information before encoding) to the POS device.

Then, the POS device issues a receipt on which the new transaction information and the updated first information (including the code and the information before encoding) are printed.

The present example embodiment as described above is able to provide an operation and effect similar to that provided by the first example embodiment.

A hardware configuration of the information processing device (server) according to the present example embodiment is illustrated in FIG. 8, similarly to that according to the second to sixth example embodiments. Details thereof are described in the second example embodiment, and therefore description thereof is omitted here.

An example of a functional block diagram of the information processing device (server) 20 according to the present example embodiment is illustrated in FIG. 20. A configuration of each unit is similar to that according to the fourth example embodiment.

The present example embodiment as described above is able to provide an operation and effect similar to that provided by the first example embodiment. Further, the aforementioned operation and effect is provided by connecting the server (information processing device 20) to an existing POS device and causing the devices to cooperate with one another. Accordingly, a burden of equipment investment can be reduced compared with a case of newly introducing a POS device (the POS device according to the first example embodiment) providing the aforementioned operation and effect.

### Eighth Example Embodiment

The present example embodiment differs from the fifth example embodiment in providing the information processing device 20 according to the fifth example embodiment by a server.

A hardware configuration of an information processing device (server) according to the present example embodiment is illustrated in FIG. 8, similarly to that according to the second to seventh example embodiments. Details thereof are described in the second example embodiment, and therefore description thereof is omitted here.

An example of a functional block diagram of the information processing device (server) 20 according to the present example embodiment is illustrated in FIG. 21. A configuration of each unit is similar to that according to the fifth example embodiment.

The information processing device 20 according to the present example embodiment may execute at least one of the specific examples 1 to 3 described in the fifth example embodiment.

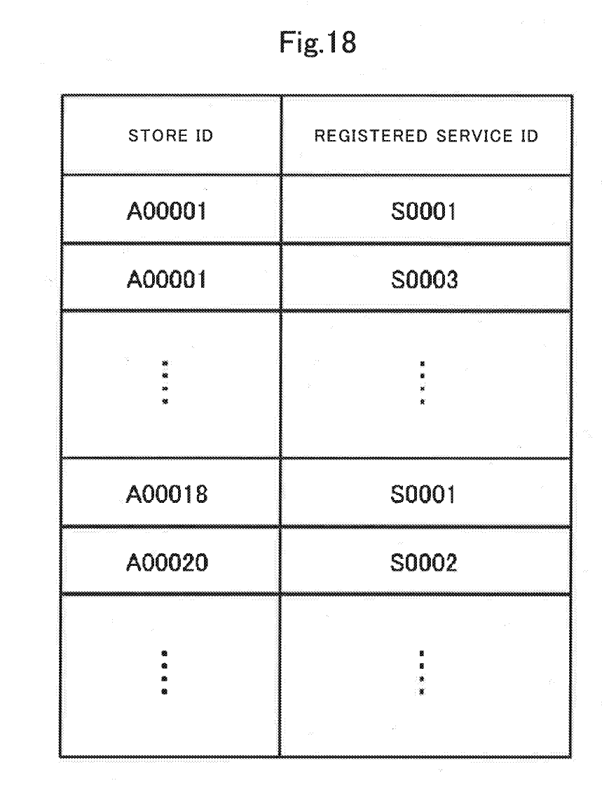

In the specific example 2, the information processing device 20 receives identification information of a store to which a POS device belongs, in addition to first information and a payment amount of a new transaction. Then, a determination unit 25 determines whether or not the store performing the new transaction participates in offering of a predetermined service, based on a list as illustrated in FIG. 18, the list associating each of a plurality of stores with service identification information of a service in which each store participates.

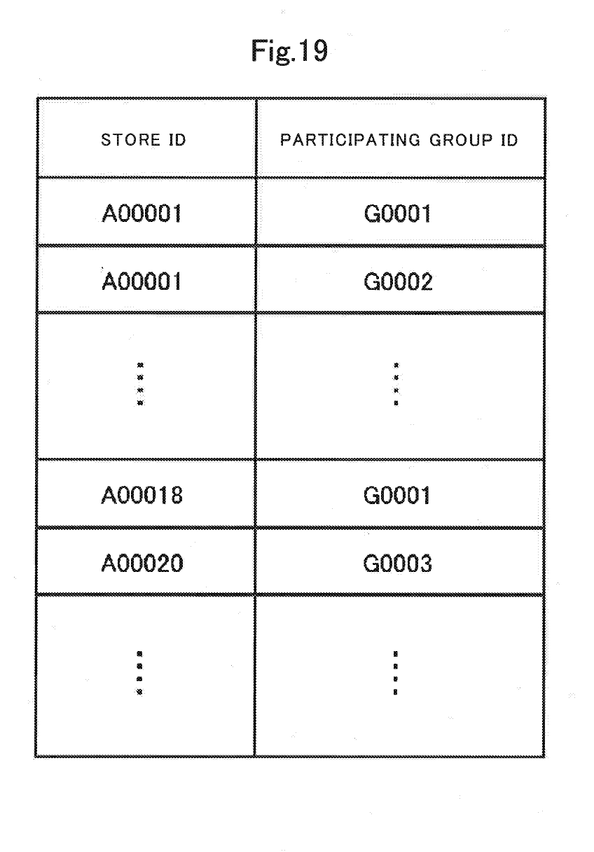

Similarly, in the specific example 3, the information processing device 20 receives identification information of a store to which a POS device belongs, in addition to first information and a payment amount of a new transaction. Then, the determination unit 25 identifies a group to which the store performing the new transaction belongs, based on a list as illustrated in FIG. 19, the list associating each of a plurality of stores with group identification information of a group to which each store belongs.

The present example embodiment as described above is able to provide an operation and effect similar to that provided by the fifth example embodiment.

### Ninth Example Embodiment

When new transaction information is input to the POS device according to the sixth to eighth example embodiments, the POS device performs checkout processing and calculates a payment amount of the new transaction. A POS device according to the present example embodiment transmits new transaction information to a server. Then, based on the new transaction information, the server performs checkout processing and calculates a payment amount of the new transaction.

The present example embodiment is able to provide an operation and effect similar to that provided by the sixth to eighth example embodiments.

Examples of reference embodiments are added as supplementary notes below.
1. A POS device including:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which acquires a payment amount of a new transaction;

an update means which updates the first information, based on the payment amount of the new transaction; and

a recording means which prints the updated first information on a newly-issued receipt on which the new transaction information is printed.
2. The POS device according to 1, wherein

the encoded first information is printed on the receipt.
3. The POS device according to 1 or 2, further including

a determination means which determines whether to update the first information, based on a payment amount of the new transaction, wherein,

when the determination means determines to perform an update, the update means updates the first information, based on the payment amount of the new transaction.
4. The POS device according to 3, wherein

the determination means determines whether a store performing the new transaction participates in offering of the service, and when the store participates, determines to perform an update, and when the store does not participate, determines not to perform an update.
5. The POS device according to 4, wherein

a plurality of pieces of the first information respectively related to a plurality of the services are printed on the receipt,

the first information further includes service identification information for identifying the related service, and

the determination means determines whether to update each of a plurality of pieces of the first information, based on a list of the service in which a store performing the new transaction participates.
6. The POS device according to 3, wherein

a plurality of pieces of the first information respectively related to a plurality of groups to which one or more stores belong are printed on the receipt,

the first information further includes group identification information for identifying the related group, and

the determination means determines whether to update each of a plurality of pieces of the first information, based on a list of the group to which a store performing the new transaction belongs.
7. The POS device according to 6, wherein

the determination means determines to update the first information related to the group to which a store performing the new transaction belongs.
8. The POS device according to any one of 3 to 7, wherein

the first information further includes information indicating an expiration date, and

the determination means determines to update the first information when the expiration date is not reached and determines not to update the first information when the expiration date is reached.
9. An information processing device including:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from a POS device;

an update means which updates the first information, based on the payment amount of the new transaction; and

a transmission means which transmits the updated first information to the POS device.
9-2. The information processing device according to 9, wherein

the first information acquisition means acquires the first information directly from an issued receipt or from the POS device acquiring the first information from an issued receipt.
9-3. The information processing device according to 9 or 9-2, wherein

the encoded first information is printed on the receipt.
9-4. The information processing device according to any one of 9 to 9-3, further including

a determination means which determines whether to update the first information, based on a payment amount of the new transaction, wherein,

when the determination means determines to perform an update, the update means updates the first information, based on the payment amount of the new transaction.
9-5. The information processing device according to 9-4, wherein

the determination means determines whether a store performing the new transaction participates in offering of the service, and when the store participates, determines to perform an update, and when the store does not participate, determines not to perform an update.
9-6. The information processing device according to 9-5, wherein

a plurality of pieces of the first information respectively related to a plurality of the services are printed on the receipt,

the first information further includes service identification information for identifying the related service, and

the determination means determines whether to update each of a plurality of pieces of the first information, based on a list of the service in which a store performing the new transaction participates.
9-7. The information processing device according to 9-4, wherein

a plurality of pieces of the first information respectively related to a plurality of groups to which one or more stores belong are printed on the receipt,

the first information further includes group identification information for identifying the related group, and

the determination means determines whether to update each of a plurality of pieces of the first information, based on a list of the group to which a store performing the new transaction belongs.
9-8. The information processing device according to 9-7, wherein

the determination means determines to update the first information related to the group to which a store performing the new transaction belongs.
9-9. The information processing device according to any one of 9-4 to 9-8, wherein

the first information further includes information indicating an expiration date, and

the determination means determines to update the first information when the expiration date is not reached and determines not to update the first information when the expiration date is reached.
10. A POS device control method including:

a first information acquisition step of acquiring first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition step of acquiring a payment amount of a new transaction;

an update step of updating the first information, based on the payment amount of the new transaction; and

a recording step of printing the updated first information on a newly-issued receipt on which the new transaction information is printed.
10-2. The POS device control method according to 10, wherein

the encoded first information is printed on the receipt.
10-3. The POS device control method according to 10 or 10-2, further including

a determination step of determining whether to update the first information, based on a payment amount of the new transaction, wherein,

in the update step, when an update is determined to be performed in the determination step, the first information is updated based on the payment amount of the new transaction.
10-4. The POS device control method according to 10-3, wherein,

in the determination step, whether a store performing the new transaction participates in offering of the service is determined, and when the store participates, an update is determined to be performed, and when the store does not participate, an update is determined not to be performed.
10-5. The POS device control method according to 10-4, wherein

a plurality of pieces of the first information respectively related to a plurality of the services are printed on the receipt,

the first information further includes service identification information for identifying the related service, and,

in the determination step, whether to update each of a plurality of pieces of the first information is determined based on a list of the service in which a store performing the new transaction participates.
10-6. The POS device control method according to 10-3, wherein

a plurality of pieces of the first information respectively related to a plurality of groups to which one or more stores belong are printed on the receipt,

the first information further includes group identification information for identifying the related group, and,

in the determination step, whether to update each of a plurality of pieces of the first information is determined based on a list of the group to which a store performing the new transaction belongs.
10-7. The POS device control method according to 10-6, wherein,

in the determination step, the first information related to the group to which a store performing the new transaction belongs is determined to be updated.
10-8. The POS device control method according to any one of 10-3 to 10-7, wherein

the first information further includes information indicating an expiration date, and,

in the determination step, the first information is determined to be updated when the expiration date is not reached, and the first information is determined not to be updated when the expiration date is reached.
11. An information processing method including:

a first information acquisition step of acquiring first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition step of receiving a payment amount of a new transaction from a POS device;

an update step of updating the first information, based on the payment amount of the new transaction; and

a transmission step of transmitting the updated first information to the POS device.
12. A program causing a computer to function as:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which acquires a payment amount of a new transaction;

an update means which updates the first information, based on the payment amount of the new transaction; and

a recording means which prints the updated first information on a newly-issued receipt on which the new transaction information is printed.
12-2. The program according to 12, wherein

the encoded first information is printed on the receipt.
12-3. The program according to 12 or 12-2, further causing the computer to function as

a determination means which determines whether to update the first information, based on a payment amount of the new transaction, wherein,

when the determination means determines to perform an update, the update means updates the first information, based on the payment amount of the new transaction.
12-4. The program according to 12-3, wherein

the determination means determines whether a store performing the new transaction participates in offering of the service, and when the store participates, determines to perform an update, and when the store does not participate, determines not to perform an update.
12-5. The program according to 12-4, wherein

a plurality of pieces of the first information respectively related to a plurality of the services are printed on the receipt,

the first information further includes service identification information for identifying the related service, and

the determination means determines whether to update each of a plurality of pieces of the first information, based on a list of the service in which a store performing the new transaction participates.
12-6. The program according to 12-3, wherein

a plurality of pieces of the first information respectively related to a plurality of groups to which one or more stores belong are printed on the receipt,

the first information further includes group identification information for identifying the related group, and

the determination means determines whether to update each of a plurality of pieces of the first information, based on a list of the group to which a store performing the new transaction belongs.
12-7. A program recording medium recording the program according to 12-6, wherein

the determination means determines to update the first information related to the group to which a store performing the new transaction belongs.
12-8. The program recording medium recording the program according to any one of 12-3 to 12-7, wherein

the first information further includes information indicating an expiration date, and

the determination means determines to update the first information when the expiration date is not reached and determines not to update the first information when the expiration date is reached.
13. A program recording medium which records a program causing a computer to function as:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from a POS device;

an update means which updates the first information, based on the payment amount of the new transaction; and

a transmission means which transmits the updated first information to the POS device.
14. A POS system including a POS device and an information processing device, wherein

an information processing device includes:

a first information acquisition means which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;

a second information acquisition means which receives a payment amount of a new transaction from the POS device;

an update means which updates the first information, based on the payment amount of the new transaction; and

a transmission means which transmits the updated first information to the POS device, and

the POS device includes

a recording means which prints the updated first information received from the information processing device on a newly-issued receipt on which the new transaction information is printed.

The present invention has been described above with the aforementioned example embodiments as exemplary examples. However, the present invention is not limited to the aforementioned example embodiments. In other words, various modes which may be understood by a person skilled in the art may be applied to the present invention, within the scope thereof.

This application claims priority based on Japanese Patent Application No. 2015-195361 filed on Sep. 30, 2015, the disclosure of which is hereby incorporated by reference thereto in its entirety.

### REFERENCE SIGNS LIST

1A Processor

2A Memory

3A Input-output interface

4A Peripheral circuit

5A Bus

10 POS device

11 First information acquisition unit

12 Second information acquisition unit

13 Update unit

14 Recording unit

15 Determination unit

20 Information processing device

21 First information acquisition unit

22 Second information acquisition unit

23 Update unit

24 Transmission unit

25 Determination unit

100 Receipt

110 Transaction information

120 First information

121 Information before encoding

122 Code

200 Computer

202 Bus

204 Processor

206 Memory

208 Storage

210 Input-output interface

212 Network interface

214 Touch panel

216 Drawer

218 Change dispenser

220 Printer

222 Reader

What is claimed is:

1. A point of sale device comprising:
a first information acquisition unit which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;
a second information acquisition unit which acquires a payment amount of a new transaction;
an update unit which updates the first information, based on the payment amount of the new transaction; and
a recording unit which prints the updated first information on a newly-issued receipt on which the new transaction information is printed.

2. The point of sale device according to claim 1, wherein
the encoded first information is printed on the receipt.

3. The point of sale device according to claim 1, further comprising
a determination unit which determines whether to update the first information, based on a payment amount of the new transaction, wherein,
when the determination unit determines to perform an update, the update unit updates the first information, based on the payment amount of the new transaction.

4. The point of sale device according to claim 3, wherein
the determination unit determines whether a store performing the new transaction participates in offering of the service, and when the store participates, determines to perform an update, and when the store does not participate, determines not to perform an update.

5. The point of sale device according to claim 4, wherein
a plurality of pieces of the first information respectively related to a plurality of the services are printed on the receipt,
the first information further includes service identification information for identifying the related service, and
the determination unit determines whether to update each of a plurality of pieces of the first information, based on a list of the service in which a store performing the new transaction participates.

6. The point of sale device according to claim 3, wherein
a plurality of pieces of the first information respectively related to a plurality of groups to which one or more stores belong are printed on the receipt,
the first information further includes group identification information for identifying the related group, and
the determination unit determines whether to update each of a plurality of pieces of the first information, based on a list of the group to which a store performing the new transaction belongs.

7. The point of sale device according to claim 6, wherein
the determination unit determines to update the first information related to the group to which a store performing the new transaction belongs.

8. The point of sale device according to claim 3, wherein
the first information further includes information indicating an expiration date, and
the determination unit determines to update the first information when the expiration date is not reached and determines not to update the first information when the expiration date is reached.

9. An information processing device comprising:
a first information acquisition unit which acquires first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;
a second information acquisition unit which receives a payment amount of a new transaction from a point of sale device;
an update unit which updates the first information, based on the payment amount of the new transaction; and
a transmission unit which transmits the updated first information to the point of sale device.

10. The information processing device according to claim 9, wherein
the first information acquisition unit acquires the first information directly from an issued receipt or from the point of sale device acquiring the first information from an issued receipt.

11. A point of sale device control method comprising:
acquiring first information from an issued receipt on which the first information is printed, the first information including at least one of a totalized amount obtained by totalizing a payment amount of a past transaction and a balance amount obtained by subtracting the totalized amount from a target amount being a lower limit for receiving a predetermined service;
acquiring a payment amount of a new transaction;
updating the first information, based on the payment amount of the new transaction; and
printing the updated first information on a newly-issued receipt on which the new transaction information is printed.

12-15. (canceled)

16. The point of sale device according to claim 2, further comprising
a determination unit which determines whether to update the first information, based on a payment amount of the new transaction, wherein,
when the determination unit determines to perform an update, the update unit updates the first information, based on the payment amount of the new transaction.

17. The point of sale device according to claim 16, wherein
the determination unit determines whether a store performing the new transaction participates in offering of the service, and when the store participates, determines to perform an update, and when the store does not participate, determines not to perform an update.

18. The point of sale device according to claim 17, wherein
a plurality of pieces of the first information respectively related to a plurality of the services are printed on the receipt,
the first information further includes service identification information for identifying the related service, and
the determination unit determines whether to update each of a plurality of pieces of the first information, based on a list of the service in which a store performing the new transaction participates.

19. The point of sale device according to claim 16, wherein
a plurality of pieces of the first information respectively related to a plurality of groups to which one or more stores belong are printed on the receipt,
the first information further includes group identification information for identifying the related group, and
the determination unit determines whether to update each of a plurality of pieces of the first information, based on a list of the group to which a store performing the new transaction belongs.

20. The point of sale device according to claim 17, wherein
the determination unit determines to update the first information related to the group to which a store performing the new transaction belongs.

21. The point of sale device according to claim 4, wherein
the first information further includes information indicating an expiration date, and
the determination unit determines to update the first information when the expiration date is not reached and determines not to update the first information when the expiration date is reached.

22. The point of sale device according to claim 5, wherein
the first information further includes information indicating an expiration date, and
the determination unit determines to update the first information when the expiration date is not reached and determines not to update the first information when the expiration date is reached.

23. The point of sale device according to claim 6, wherein
the first information further includes information indicating an expiration date, and
the determination unit determines to update the first information when the expiration date is not reached and determines not to update the first information when the expiration date is reached.

24. The point of sale device according to claim 7, wherein
the first information further includes information indicating an expiration date, and
the determination unit determines to update the first information when the expiration date is not reached and determines not to update the first information when the expiration date is reached.
